(19) United States
(12) Patent Application Publication
(10) Pub. No.: US 2009/0248582 A1
(43) Pub. Date: Oct. 1, 2009

(54) System to enable a telecom operator provide financial transactions services and methods for implementing such transactions

(75) Inventor: Serge BARTHELEMY, Beijin (CN)

Correspondence Address: BUCHANAN, INGERSOLL & ROONEY PC, POST OFFICE BOX 1404, ALEXANDRIA, VA, 22313-1404, US

(73) Assignee: Paycool International Limited, Hong Kong (CN)

(21) Appl. No.: 12/453,979

(22) Filed: May 28, 2009

Related U.S. Application Data
(63) Continuation of application No. 10/512,775, filed on May 9, 2005.

(51) Int. Cl. G06Q 40/00; H04L 9/32

(52) U.S. Cl. 705/71; 705/44

(57) ABSTRACT

The invention relates to a system, enabling subscribers of a wireless Telecom Operator to execute financial transactions with a mobile phone, or an electronic device which can be connected to the wireless communication network, wherein a subscriber has one or several Financial Transaction Accounts open and managed by the Telecom Operator, which can receive monetary deposits, and on which debit and credit operations can be executed. The system is composed of a Transaction Processing Platform, which is installed on the computers of the Telecom Operator, is connected to the wireless communication network, is interfaced with other elements of the Telecom Operator, manages the Financial Transactions Accounts, verifies/executes financial transactions sent by the subscribers, and executes other tasks like confirmations of transactions, account statement preparation, reporting, etc. The system is also composed of a client software that runs on the Mobile Phone of the subscriber or his connectable electronic device or on the Subscriber Identify Module which is inserted in the mobile phone or connectable electronic device. Such client software enables the subscriber to prepare, validate and send through the wireless communication network, transactions orders to the Transaction Processing Platform.

### TECHNICAL FIELD

The invention relates to a wireless telecommunication system, and more particularly to a system which enables a wireless telecom operator to provide financial transactions services; and methods for implementing such transactions through a wireless communication network.

### BACKGROUND OF THE INVENTION

The development of networks, like the Internet, has been instrumental in the emergence of new concepts like Electronic commerce. However Electronic payment systems have been lagging behind such recent developments, and today all attempts to implement Electronic digital payment systems have faced the challenges to be really simple, effective, user friendly, secure, scalable, easy to deploy, etc. . . . In most case digital payment systems require the implementation of complex architecture and the intervention of many parties and especially financial institutions, like banks or others. Furthermore the implementation of such systems generally required the installation of dedicated infrastructure, making them difficult to deploy massively among consumers. Digital systems have already enjoyed a great success in the telecommunication sector and in particular with mobile telephone systems like GSM, CDMA and W-CDMA, CDMA2000 or others. Those systems are providing consumers with more and more capabilities and performances. As such those systems have become, in just few years, extremely popular, and a significant part of the population is now using consistently digital mobile phones, not only for voice but also for data transfer. The digital mobile phone has become a natural or even indispensable companion for many people; and it is naturally envisaged to extend its use through this invention.

### SUMMARY OF THE INVENTION

The object of this invention is to bring a solution to the complexity issue of electronic financial transactions implementation.

This invention describes an innovative system which will enable a wireless telecom operator to provide financial transactions services to its subscribers. The invention is characterised by the fact that the system does not require the implication of any financial institution (bank, savings bank, credit card organisation, or other); does not require the installation of a dedicated network infrastructure, does not need the use of other traditional means of payment like credit cards or debit cards; does not require the use of special devices by the subscribers; but rather makes full use of one operator's existing wireless communication network and system, as well as existing mobile phones. It is characterised by the fact that the Telecom Operator opens and manages Financial Transaction Accounts for its subscribers and provides them with tools and rights to execute from their mobile phone or connectable electronic device, financial transactions. Since the Financial Transactions Accounts, the methods and corresponding tools are operated and controlled by one single actor, the Telecom Operator, this simplifies greatly the system and its security architecture. It also avoid conflicts of interests between otherwise, multiple parties.

The system is composed of a Transaction Processing Platform, which is installed on the computers of the Telecom Operator, is connected to the wireless communication network, is interfaced with other elements of the Telecom Operator system (Subscriber's data base, authentication centre, accounting system, etc. . . . ), manages the Financial Transactions Accounts, verifies/executes financial transactions sent by the subscribers, and executes other tasks, like confirmations of transactions, account statement preparation, reporting, etc. . . . This platform implements the methods for executing the financial transactions which are described in this invention.

The system is also composed of client software that runs on the mobile Phone of the subscriber or his connectable electronic device, or on the Subscriber Identity Module (SIM for GSM, UIM for CDMA, USIM for 3G UMTS, etc. . . . ) which is inserted in the mobile phone or connectable electronic device. Such client software enables the subscriber to prepare, validate, and send through the wireless communication network, transactions orders to the Transaction Processing Platform, according to such methods which are described in this invention.

This system allows the subscribers to execute those transactions, such as payment to another person, payment to a merchant etc. . . . in a simple, secure, and user friendly way by using their digital mobile phone or electronic equipment connected to the wireless communication network. The benefits of such system are easy to imagine. But it can bring new possibilities which today do not exist yet, like for example:
Instant payment by millions of people to one single organisation: this would be the case for a donation campaign organised around a TV show. By displaying one single number on the TV (on which to donate), a large number of viewers can use their mobile phone to make a donation, while the donation organiser can follow in real time the results . . . .
Possibility to make payment to a party in an anonymous way.
Possibility to make payment to an unknown party, which will only be identified by a number.

This system and methods for executing financial transactions represent an innovative alternative to existing means of payment, such as cash, credit or debit cards, checks, money transfer, as they cumulate in one single solution advantages of all those means.

### BRIEF DESCRIPTION OF DRAWINGS

The invention will be described more in detail below with reference to the appended drawings, in which:

FIG. 1 is a representation of the system overview and how the Transaction Processing platform is connected to the wireless communication network and interfaced with the Telecom Operator sub-systems.

FIG. 2 shows the flow chart of transaction scenario 1 as described in detail below; it represents the different steps. On the right side icons illustrate where the tasks are performed: Mobile Phone, TPP.

FIG. 3 illustrates the different screen displays on Payer's Mobile Phone which are mentioned in FIG. 2.

FIG. 4 illustrates the different screen displays on Payee's Mobile Phone which are mentioned in FIG. 2.

### DETAILED DESCRIPTION OF PREFERRED EMBODIMENTS

This invention is characterised by the fact that the Telecom Operator provides the subscribers with a Financial Transaction Account (FTA). This Financial Transaction Account is very much like a current account in a bank, and allows its owner to make deposits, receive payments and money transfers from third parties, execute payments to third parties, have overdraft facility, get credit, etc. . . . An FTA Agreement is signed between the Telecom Operator and the subscriber, and defines the terms and conditions of use. Those conditions may include but are not limited to: general conditions of use of FTA, minimum balance, credit or overdraft limits, interest charges, interests earned on deposits, transactions values limits, service and transaction charges, billing conditions, discounts on transactions volumes, privacy, anonymity of payments, credit redemption, credit reload, pre-payment, etc. . . .

Opening a Financial Transaction Account is an easy process since each subscriber is already clearly identified by the Telecom Operator's system with a series of personal data such as: name, address, ID card number, Bank account number, etc. . . .

As the result of his subscription, the subscriber gets a unique Mobile Phone Number which is directly linked to his Phone Account in the billing and accounting system of the Telecom Operator.

This invention is characterised by the fact that the “Mobile Phone Number” of a subscriber is also used to identify his Financial Transaction Account. As such the subscriber only needs to mention his Mobile Phone Number to receive payment transactions from third parties directly on his FTA.

In an alternate embodiment of the invention the Telecom Operator provides a special number (different from the Mobile Phone Number) for the Financial Transaction Account: “FTA Number”. This is particularly convenient when the subscriber wants to keep a certain level of privacy and does not want to disclose his Mobile Phone Number to too many people.

As such a subscriber who wants to register to the Financial Transaction service will have two accounts, one Phone Account where his mobile phone activity is logged, and one Financial Transaction Account dedicated to his deposits and financial transactions settlement.

In an alternate embodiment of the invention the Phone Account and the Financial Transaction Account are merged in one single account. This is particularly useful in case of Prepaid Telephone Account. This allows the Telecom Operator to provide “debit only” financial transaction service capability to a prepaid subscriber.

The subscriber will then be able to execute financial transactions in a simple way using his mobile phone and methods which are described further in this document.

In an alternate embodiment of the invention, the subscriber can use mobile equipments other than his Mobile Phone; those equipments can be, but are not limited to: personal computer, PDA, organiser, pocket computer, a digital camera, or any other electronic equipment with a capability to be identified and connected to the wireless communication network of the operator. Further below those equipments are called “connectable electronic devices”.

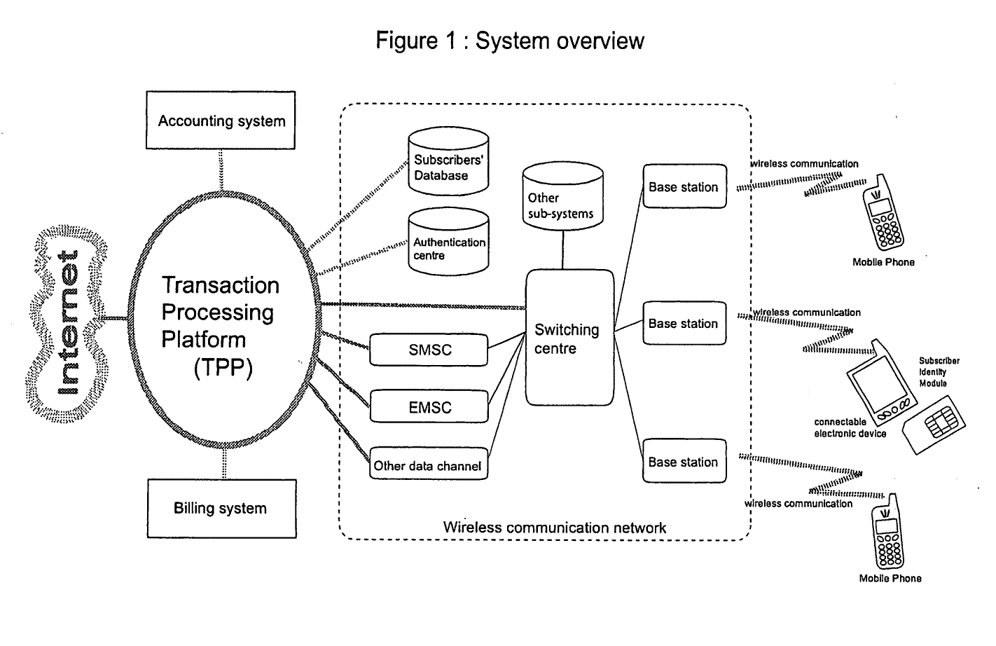

Referring to FIG. 1, this invention is also characterised by the fact that the system is composed of the following elements or sub-systems:

### A Software Platform: the Transaction Processing Platform (TPP) 10

The invention is characterised by the fact that this platform can either run on the existing computers of the Telecom Operator, or on a dedicated computer. It is connected to, and interfaced with, some key elements of the operator's wireless system, such as but not limited to: the subscribers' database 12, the authentication module 14, the various data channels 16, the billing system 18, the accounting system 20, internet 22, etc. . . .

This platform is at the heart of the system, and performs a series of functions such as but not limited to:

Receiving through a data channel 16 and interpreting transaction orders from mobile phones 24.
Receiving through the data channel 16 and interpreting information or account status requests
Processing transactions (executing the relevant credit and debit operations on the various accounts)
Settling transactions
Selecting adequate data channel 16 to send and/or receive data to/from mobile phones 24
Sending transaction notices, confirmations, or refusal to the relevant parties
Sending FTA status to his owner
Managing, updating, modifying FTA conditions and parameters as a result of commercial conditions established between the Telecom Operator and the subscriber
Charging, invoicing, processing the transaction fees to the relevant parties and according to terms and conditions of each FTA
Establishing FTA statements
Establishing account ledger, and accounting
Providing online report for FTA owners
Generating automatically alerts and advices,
Generating and sending printed reports like statement of account, transactions notices, accounting reports, etc. . . .

### A Client Software Program: Mobile Transaction Management Software (MTMS)

This invention is characterised by the fact that a client software is stored either in a memory of the mobile telephone 24 or connectable electronic device 26, or a memory of the Subscriber's Identity Module 28 (SIM card for GSM, or UIM card for CDMA, USIM card for 3G UMTS, or equivalent), and able to be executed by one of the microprocessors of the mobile phone or connectable electronic device or by the microcontroller of the SIM or by both the SIM and the processor of the mobile phone or connectable electronic device.

This client software enables the execution of financial transactions from the Mobile Phone 24 or connectable electronic device 26 according to the methods described below. It also enables to retrieve information on the status and situation of the Financial Transaction Account. For this purpose it performs a series of functions such as but not limited to:

Displaying information in a structured manner on the Mobile Phone or connectable electronic device screen to prompt the subscriber for actions
Generating screens and fields for transaction data capture
Prompting password input
Authenticating the subscriber
Preparing data file of a transaction
Encrypting (when needed) transaction related data files
Generating digital signature of transaction related data files
Detecting the most appropriate data channel to be used according to the mobile phone or connectable electronic device capabilities, and transaction data characteristics (size, priority, etc. . . . )
Sending through the chosen data channel, the transaction data file to the Transaction Processing Platform 10
Managing the Financial Transaction Service parameters at the level of the Mobile Phone or connectable electronic device
Managing the activation or the de-activation of the Financial Transaction Service in the Mobile Phone or connectable electronic device
Receiving, interpreting, decrypting, transaction related data files
Verifying digital signatures
Displaying data and information coming from the TPP such as but not limited to transaction confirmation, transaction denial, FTA balance or status, answer to request, update of FTA parameters, update of client software, etc. . . .

The invention is also characterised by the fact that this software is loaded in a memory of the Mobile Phone 24 or connectable electronic device 26, or in the memory of the SIM 28 (or UIM, or USIM) upon enrolment of the subscriber to the Financial Transaction Service. This is done usually at the Point Of Sale (POS) of the Telecom Operator by means of an appropriate connecting device between the POS and the Mobile Phone or connectable electronic device; or in the case of a SIM (or UIM or USIM) by means of card reader connected to the POS.

In another embodiment of the invention, this software is already preloaded in the memory of the Mobile Phone or connectable electronic device, or of the SIM (or UIM or USIM); in such case it is only needed to activate the use of this software upon enrolment. This is either done directly at the Point Of Sale by inputting manually an activation code, or by sending Over The Air from TPP to the Mobile phone such activation code.

In another embodiment of the invention, this software is downloaded Over The Air from the TPP directly to the Mobile Phone or connectable electronic device or the SIM (or UIM or USIM), and activated automatically upon enrolment of the subscriber to the Financial Transaction Service.

The invention is characterised by the fact that the MTMS contains or manages a file of parameters which represents the terms and conditions mentioned in the FTA Agreement, as well as the current balance and/or credit limit of the FTA.

The invention is also characterised by the fact that MTMS compares transaction data against those parameters before a transaction order is sent to the TPP.

This file can be updated regularly and in particular when there are changes in the parameters or balance of FTA.

This is particularly interesting as the MTMS can make a series of validity checks on the transaction as it is prepared by the subscriber and prompt the subscriber for changes if the transaction data he has input is incompatible with his FTA situation. This has also the advantage of reducing the load on the data network and on the TPP, by avoiding invalid transactions being sent to the TPP.

### Transmission of Transactions Related Data and Information

This invention is characterised by the fact that the transfer of data related to financial transactions and information between the TPP and mobile phones or connectable electronic devices (either way) is using one or several types of data channel which exist in wireless communication networks.

In digital wireless telecom systems several data channels are available and more are to come in the future. For illustration and simplicity purposes, the example of GSM is taken. A GSM or UMTS system can provide several data channels like:

### USSD: Unstructured Supplementary Service Data

### HSCSD: High Speed Circuit Switched Data

### SMS: Short Message Service

### GPRS: General Packet Radio System

### EMS: Enhanced Message Service

### MMS: Multimedia Message Service

All those data channels have different characteristics, capabilities, advantages and drawbacks. Also mobile phones do not necessarily support all six above mentioned channels; as of today all GSM mobile phones support USSD and SMS while only newer or future phones support GPRS, EMS or MMS.

This invention is characterised by the fact that at each time the TPP needs to send transaction related data or information to a mobile phone or connectable electronic device; it will select the most suitable data channels to be used. The system can use one or several data channels for one transfer and the choice of the data channels will depend on the several considerations such as but not limited to:

Type and capabilities of mobile phone or connectable electronic device,
Is the mobile phone “power ON” or “power OFF”?

### Time

Data channels or network load
Actual location of mobile phone

### Priority

Amount of data or size of file
Whether the data is encrypted or not

This invention is also characterised by the fact that each time the mobile phone or connectable electronic device needs to send transaction data or data request; the MTMS will select the most suitable data channel to be used. The choice of the data channel will depend on the several considerations such as but not limited to:

Type and capabilities of mobile phone or connectable electronic device

### Time

Instruction from TPP
Data channels or network load

### Priority

Amount of data or size of file
Whether the data is encrypted or not

### Methods for Executing Financial Transactions

This invention is characterised by the fact that the financial transactions are initiated and/or executed by the subscriber with his Mobile Phone or connectable electronic device duly loaded with the software (MTMS) described above, and following the methods described below.

The main types of financial transactions are generally payment transactions; those transactions can be implemented and executed in a large variety of ways. For the purpose of understanding the invention the following description is limited to a few ways only, which are called transactions scenarios, and probably represent the most frequently encountered situations.

### Transactions Scenarios

Each scenario involves a payer (B) who wants to send a payment to a payee (A) who receives such payment. In some cases “A” initiates the process by sending “B” a payment request.

Scenario 1: Payer (B) generates a Payment Order (PO) in favour of the Payee (A), without any intervention from “A”.

Scenario 2: Payee (A) generates and sends a Payment Request (PR) to the Payer (B); “B” receives the PR, and in case of acceptance generates a Payment Order (PO) in favour of “A”.

Both the Payer and the Payee have signed a FTA agreement with the same Telecom Operator, have their own Financial Transaction Account, and can benefit from the Financial Transaction Service provided by the Telecom Operator. Both, “A” or “B” can be individuals, shops, or organisations (companies, associations, clubs, etc. . . . ).

### Transaction Process

For illustration purpose and simplicity, the process below is described, using the GSM system which is the most widely used digital mobile telephone system in the world to date.

### Scenario 1: Simple Payment Scenario

A Payer (B) wants to pay the Payee (A) an amount of X $ with his Mobile Phone or connectable electronic device by way of the Financial Transaction Service. Because “B” knows “A” or is able to identify “A” by his Mobile Phone Number or his FTA Number, “B” will generate and send a Payment Order (PO) of value X $ to “A”.

This is a very common scenario of someone who wants to send money to a parent or a relative; or someone who wants to pay bill (electricity, phone, rent, etc. . . . ); or who wants to make a donation as mentioned above.

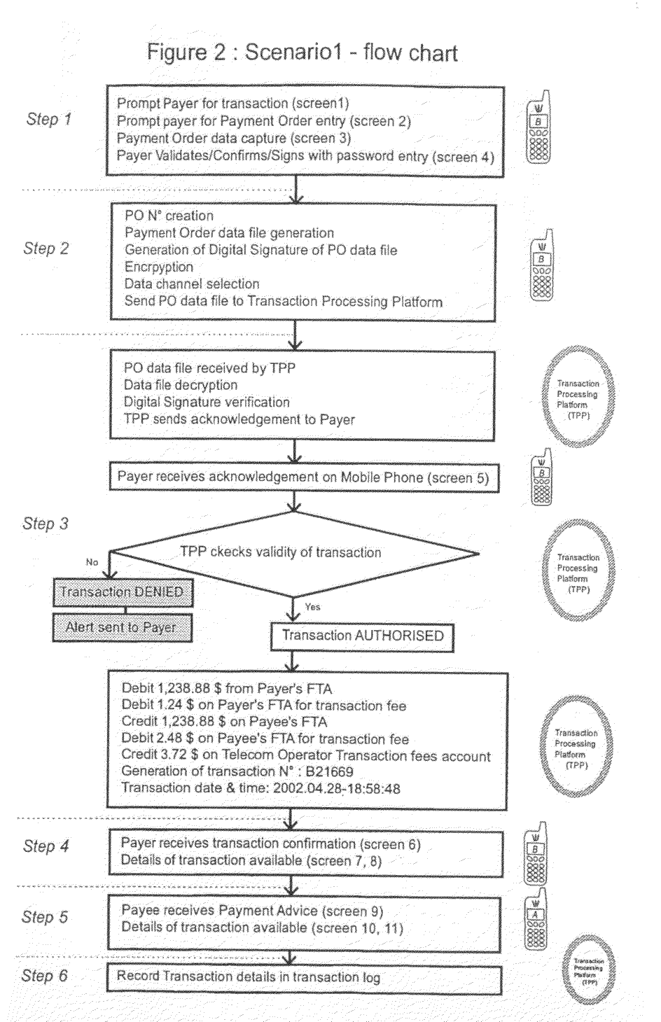

This invention is characterised by a method of generating a Payment Order directly from the Mobile Phone or connectable electronic device, sending the Payment Order to the Transaction Processing Platform, having the TPP process, execute the payment to “A”, confirm execution of such payment to “A” and “B”. The method is decomposed in few steps that are further described below, and illustrated in the flow chart of FIG. 2.

This invention is also characterised by the fact that a payment transaction can be made anonymous. In this case the Payee will receive the payment without knowing who the Payer is. The advantages of such possibility are obvious.

This invention is also characterised by the fact that the payment execution date and time can be chosen by the payer.

### Step 1: “B” Prepares and Signs the Payment Order (PO)

For this purpose “B” activates on his handset, through a menu selection, the Financial Transaction function. This is easily enabled with a SIM Tool Kit (STK) menu in the GSM system.

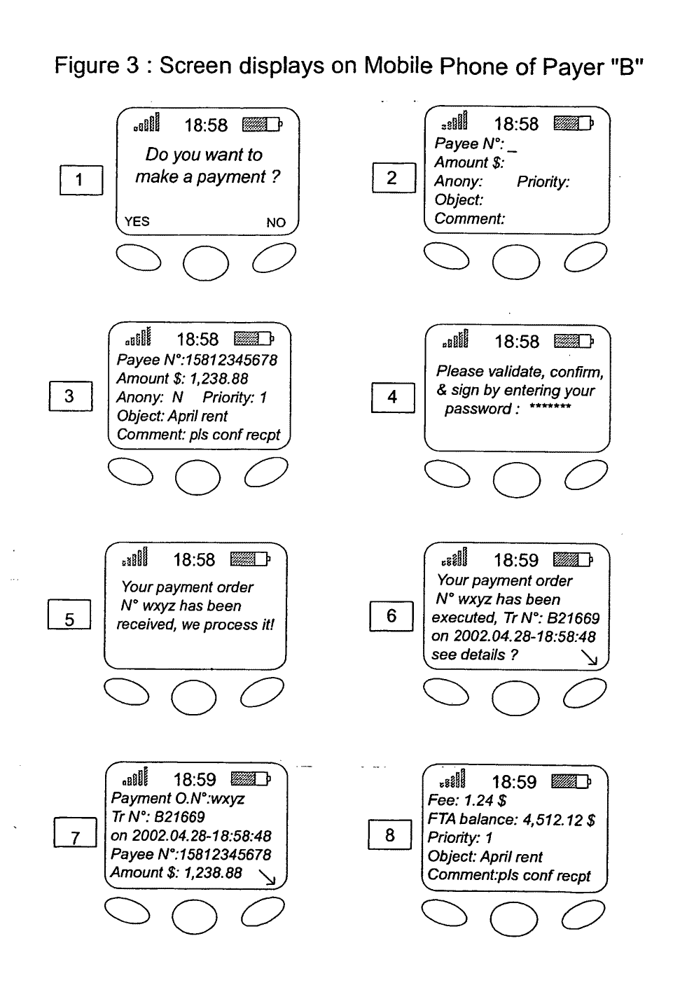

Referring to FIG. 3, the handset displays a screen and prompts “B” to enter the following data:

### Payee N^{o}: “A” Mobile Phone Number or “A” FTA Number, (15812345678 in FIG. 3)

### Amount $: X (1,238.88 in FIG. 3)

### Anonymous: Y or N (for YES or NO)

Priority: (priority level)
Object: (optional)
Comments: (optional)

Once “B” has keyed in all the data required, he presses the YES key on his handset to finish the PO input. The MTMS then makes a series of checks, such as but limited to:

Check Mobile Phone Number or FTA Number format
Check the amount X to be paid against FTA balance and/or credit limit, and other FTA agreement parameters.

If the data input by “B” is found valid by MTMS, the handset displays a new screen with the data concerning the PO, and adds a PO number “wxyz”, then prompts “B” to validate, confirm and sign.

If this not the case, the MTMS displays an alert, or generates an audible message requiring “B” to modify his PO. This can be for example the amount X $ which is beyond FTA agreement authorised limit, etc. . . .

Validation/Confirmation/Signature is done by keying a password (string of alpha and/or numeric characters) which is kept secret by “B”. In another embodiment of the invention the Validation/Confirmation/Signature of the PO is triggered using another authentication means depending on the capabilities of the handset or connectable electronic device.

Such means can be:

Finger print recognition, if the handset is equipped with a finger print sensor.
Voice authentication, if a voice authentication algorithm can run on the handset.
Face recognition, if the handset is equipped with digital camera and a face authentication algorithm is installed
Any other authentication method, using a biometric means or not, could also be envisaged.

Once Validation/Confirmation/Signature is done, “B” has nothing more to do.

### Step 2: Sending the Payment Order to TPP

This invention is characterised by the fact that, once

Validation/Confirmation/Signature is done by “B”, the MTMS in the handset generates a data file (POB(x,A)) with the data of the PO, and date & time on which it has been validated.

This invention is also characterised by the fact that the MTMS generates a digital signature (DS(POB)) of POB(x,A), using a crypto algorithm and a secret key that are available in a memory of the handset or connectable electronic device. They can be the algorithm and the secret key that are used by the telecom network to authenticate the Mobile Phone; or they can be a Financial Transaction dedicated algorithm and key.

In another embodiment of the invention, the Telecom Operator uses a Public Key Infrastructure (PKI), and provides each FTA subscriber with a Private and a Public key which are securely stored in a memory of the Mobile Phone or connectable electronic device or in a memory of the SIM. A public key algorithm is used by MTMS and TPP for the purposes of generating digital signatures, encrypting transactions data files, decrypting same files, verifying digital signatures, etc. . . .

In another embodiment of the invention, the crypto algorithm and the key are stored in a secure memory of the SIM, and the SIM processor generates and/or verifies the digital signature.

Once the digital signature is generated, MTMS selects the most suitable data channel (as mentioned above), formats the file according to the data channel selected and sends through the data channel the data file (POB(x,A) together with the digital signature DS(POB) to the Transaction Processing Platform (TPP).

In another embodiment of the invention the data file (POB(x,A) is encrypted using the same algorithm and key as the ones used in the digital signature generation; or in the case of use of a PKI, the data file will be encrypted using the public key of TPP.

The data file (PO_{B}(x,A) is at the same time stored in the memory of the handset or the memory of the SIM.

### Step 3: Processing of the Payment Order by TPP

Once the data file POB(x,A) with the corresponding digital signature DS(POB) are received by TPP; TPP is able to detect the originator as being “B”.

TPP verifies the digital signature DS(POB) (as being generated by “B” and applied to POB(x,A)), this permits it to authenticate “B” as the actual originator of the PO. TPP adds a time stamp (date & time) generated by TPP's own internal clock, and extracts the data of the Payment Order sent by “B”.

TPP sends back to “B” an acknowledgement message whose form will depend on the priority selected by “B”. Following is an example of message sent and that will be displayed on the handset screen: “Your PO N^{o} wxyz has been received, execution result will be sent to you soon. Thank you.”

If the data file has been encrypted, then the first operation realised by TPP is to decrypt the file with the appropriate algorithm and key.

Then TPP executes a series of checks in order to validate and execute the transaction.

TPP verifies if the Payee “A” designated by his Mobile Phone Number or his FTA Number is actually a FTA subscriber or not. TPP then checks the situation of “B” FTA parameters contained in the FTA agreement against the amount X $ to be paid to “A” (current balance, overdraft, credit limit, transaction limit, etc. . . . ).

After those validity checks have been performed on the PO sent by “B” in favour of “A”, TPP is able to authorise or deny the transaction, and two situations may occur:
Transaction is authorised
Transaction is denied

### 1-Transaction is Authorised

This invention is characterised by the fact that TPP processes the transaction, and accomplishes the following operations:

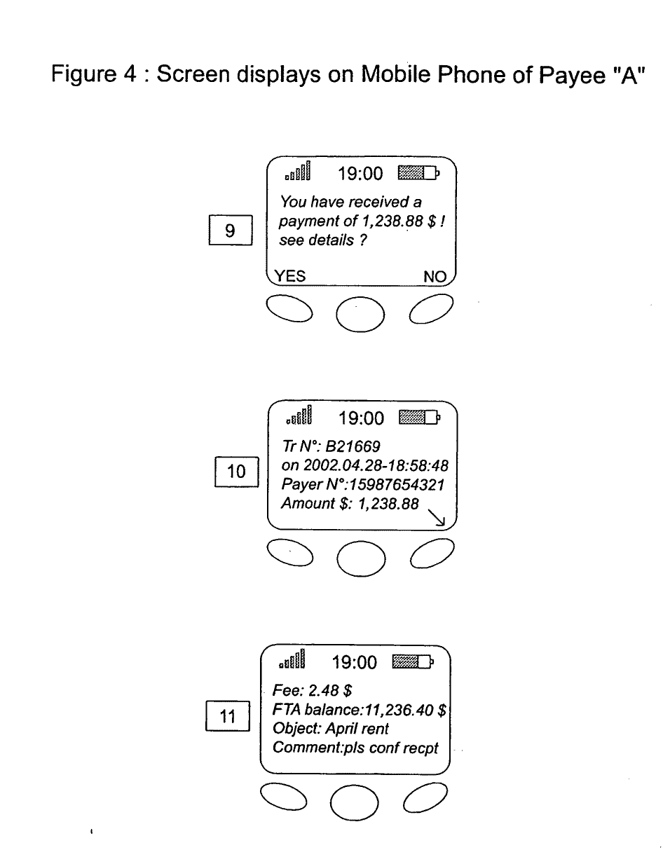

TPP debits the amount of the PO i.e. X $, from “B” FTA.
TPP debits an amount Y $ (1.24 $ in FIG. 3 screen 8) corresponding to the transaction charge (if any) from “B” FTA. This transaction charge is defined in the FTA agreement between the Telecom Operator and “B”.
TPP credits the amount X.$ on “A” FTA.
TPP debits an amount Z $ (1.48 $ in FIG. 4 screen 11) corresponding to the transaction charge (if any) from “A” FTA. This transaction charge is defined in the FTA agreement between the Telecom Operator and “A”.

After those debit and credit operations the balances of each FTA become:

### For “B”->BalanceB2=BalanceB1−X−Y.

### For “A”->BalanceA2=BalanceA1+X−Z.

TPP generates a Transaction Number to identify this transaction.
TPP credits Y+Z to the Telecom Operator's Transaction fees account.

In another embodiment of the invention, the transactions fees Y and/or Z are charged to the respective phone bills of “B” and/or “A”.

### Step 4: Confirming Transaction Execution to “B”

This invention is characterised by the fact that, TPP generates a Transaction Confirmation Notice to “B” and containing the following data:

Transaction Number (B21669 in FIG. 3, screen 6)

### PO Number

Date & time of transaction execution (2002.04.28-18:58:48 in FIG. 3 screens 6,7)

### Payee: “A” Mobile Phone Number or FTA Number

### Amount: X $

### Transaction Charge: Y $

New FTA balance: BalanceB2 (4,512.12 $ in FIG. 3 screen 8)
If payment is anonymous: YES or NO
Object of the payment (as sent by B)
Comments (as sent by B)

The data concerning this Transaction Confirmation Notice is formatted by TPP according to the data channel that is used and sent to the Payer “B”.

In another embodiment this data is encrypted with the relevant algorithm and key, and sent to “B”.

“B” can display this Notice on the screen of his handset or connectable electronic device. This notice is also recorded in a memory of his handset or a memory of the SIM; the record of Payment Order is then erased.

The memory in the handset or in the SIM is configured in such a way as it can record several transactions made by “B”. This enables “B” to check the accuracy of the statement of account provided to him by the Telecom Operator on a regular basis.

### Step 5: Sending Payment Advice to “A”

The invention is characterised by the fact that TPP generates a Payment Advice to “A” with the following data:

Transaction number
Date & time of transaction
Amount received: X $

### Transaction Charge: Z $

New FTA balance: BalanceA2 (11,236.40 $ in FIG. 4 screen 11)
Payer: “B” Mobile Phone Number or FTA Number or undisclosed (if anonymous)
Object: (as sent by “B”)
Comments: (as sent by “B”)

TPP first sends an alert to “A” to inform “A” of a receipt of a Payment. Following is an example of alert: “You have received a payment of X $ on your FTA. Please see details of transaction in the Payment Advice.”

The data concerning this Payment Advice is formatted by TPP according to the data channel that is used and sent to the Payee “A”.

In another embodiment this data is encrypted with the relevant algorithm and key, and sent to “A”, and reciprocally decrypted by the MTMS on “A” handset.

As shown in FIG. 4, “A” can display this Notice on the screen of his handset. This notice is also recorded in the memory of his handset or of the SIM.

The memory in the handset or in the SIM is configured in such a way as it can record several transactions received by “A”. This enables “A” to check the accuracy of the statement of account provided to him by the Telecom Operator on a regular basis.

### Step 6: Recording the Transaction in TPP

This invention is characterised by the fact that, TPP records in a log of transactions, all the transaction details (Transaction number, date & time of receipt of PO from “B”, PO number, date and time of execution of the transaction, Payer (B) Mobile Phone Number or FTA Number, Payee (A) Mobile Phone Number or FTA Number, amount paid X $, if payment anonymous or not, priority, Object of the payment (as sent by B), Comments (as sent by B), transaction charge on “B”: Y $, transaction charge on “A”: Z $; date & time of confirmation to “B” and data channel used; date & time of confirmation to “A” and data channel used, Digital signature).

This log is particularly useful for the management of all the Financial Transaction Accounts, and for accounting purposes.

### 2-Transaction is Denied

This invention is characterised by the fact that, TPP sends immediately an alert to “B”, through the quickest data channel, to notify him that his Payment Order N^{o} wxyz is rejected and the reason for denial. The alert will be displayed on the handset of the Payer (B).

As an example such alert could have the following form: “Your PO N^{o} wxyz for amount X $, is rejected. Reason: your overdraft will pass authorised limit. Please contact your FTA adviser.”

No debit or credit is made on “B” and “A” Financial Transaction Accounts; no advice is sent to “A”.

The PO recorded in the memory of “B” handset, or in the memory of the SIM, is updated with the mention “Rejected: date & time”.

The PO details are registered in a log of rejected transactions.

Scenario 2: Payment with Preliminary Request from the Payee

In this scenario the Payee (A) is addressing a Payment Request (PR) via the TPP to the Payer (B).

This can, for example happen in a retail shop, where the shop keeper is interested to receive a payment directly on his FTA.

This obviously supposes that “B” had previously given his Mobile Phone Number or his FTA Number to “A” by whatever means.

To generate the Payment Request “A” will activate the adequate function on his mobile phone through a menu selection. This is generally enabled with the SIM Tool Kit (STK) menu in the GSM system.

The handset displays a screen and prompts “A” to enter the following data:

### Payer N^{o}: “B” Mobile Phone Number or “B” FTA Number

### Amount $: X

PR N^{o}: abcde
Object: (optional)
Comments: (optional)

Once the PR input is finished “A” activates the send command. The MTMS of “A” handset select the most appropriate data channel, creates a file formatted for this data channel and send the file to TPP. Upon receipt of this file TPP recognises that it is a Payment Request sent by “A” and destined to “B”. TPP makes a preliminary verification to determine if such potential transaction may be authorised or not and sends an alert to “B”.

If the transaction could be authorised: this alert will contain all data concerning the PR, and a mention that a corresponding Payment Order could be authorised. The alert is then sent to “B” through the appropriate data channel, and displayed on “B” handset.

As an example this alert could have the following form:

### Payment Request:

### From: “A” Mobile Phone Number or “A” FTA Number

### Amount: X $

PR N^{o}: abcde
Object: “text . . . ”
Comments: “text . . . ”
This transaction can be authorised! If you want to pay press YES

By pressing YES “B” gets automatically a Payment Order fully ready on his handset or connectable electronic device, for him to Validate/Confirm/Sign as described earlier in scenario 1. Then the process continues as described in scenario 1.

If the transaction could not be authorised: alerts are sent immediately to both “B” and “A” mentioning that a payment transaction corresponding to the PR sent by “A” would not be authorised.

As examples the alert could have the following form:

Alert to “A”: “Sorry the transaction referring to your PR N^{o} abcde to “B” would not be authorised!”

Alert to “B”: “you have received a PR N° abcde, for X $, from “A”. This transaction will not be authorised. Reason: your FTA balance is not enough.”

This method has several advantages for both the Payer and the Payee.

It permits the Payee to get an immediate feedback from TPP to know whether the Payer can actually pay the amount requested.

It is also very convenient for the Payer, since the PO can be generated automatically with the data received from the PR. As such the Payer does not need to spend time inputting the data to prepare the PO; he just has to Validate/Confirm/Sign it.

In another embodiment of the invention the Payment Request (PR) may be sent directly from “A” to “B” through a messaging service (SMS, EMS, MMS, or other) without transiting through TPP. In this case no preliminary verification can be made by TPP; and no alert can be sent to either.

In this case “A” generates a specially structured Message using the corresponding feature of MTMS.

One form of the Message can be as follows:

Hello, please pay: “X $”

### To: “A” Mobile Phone Number or FTA Number

PR N^{o}: abcde
For: “object”
Comments: “text if any”

This Message is directly sent to “B”.

Upon receipt, such Message is recognised by “B” handset MTMS as being a Payment Request and is displayed in such a way to enable a simple and quick answer from “B”.

“B” has just to press the YES or NO key of his handset to start generating the corresponding Payment Order in favour of “A”.

In case of acceptance from “B”, “B” can generate a Payment Order in exactly the same way as in scenario 1; but in this case “B” does not need to key in all the data required to generate the Payment Order as he can retrieve it from the Message containing the Payment Request sent by “A”.

### Other Transaction Scenarios

For the purpose of illustrating and allowing a good understanding of the invention, two main transaction scenarios have been described in detail. This invention is characterised by the fact that it allows implementing other transaction scenarios such as but not limited to:
Defered payment, transaction scenario: this is similar to scenario 1, but actual payment (i.e. debit and credit operations) is executed at a later date than the Payment Order. In this case the payer adds in his PO, the execution date on which payment should be made. This can be interesting for the payment of bills on a fixed date (electricity bill, apartment rent, phone bill, etc. . . . ).
Defered payment with Payment Request, transaction scenario: this is similar to scenario 2 but with a defered payment as described above.
Conditional payment, transaction scenario: this generally a defered payment scenario where payment is actually executed when a set of conditions are met. Conditions could be met by “A” and/or “B” or by a third party “C”. This can be interesting in such situations where the payer agrees to pay only upon or after successful delivery of goods or services.

This can be illustrated by the following example:

“B” buys books from “A”; the books will be delivered by mail, and “B” agrees to pay only upon receipt of the books. The condition for payment will then be the confirmation of delivery by the Post Office (C). In this case “A” will emit a PR that will be accepted by “B”, who will emit the corresponding PO in the same manner as described in scenario 2. However payment will be executed by TPP only upon confirmation of receipt of the books. On the occasion of the delivery “C” sends to TPP a Delivery Confirmation Notice (DCN) with the following data:

### DCN N^{o}: 123456

### Sender: “A” Mobile Phone Number or FTA Number

PR N^{o}: abcde

### Receiver: “B” Mobile Phone Number or “B” FTA Number

Goods received on: date & time

Upon receipt, TPP sends this DCN to “B”. “B” receives this notice that he can display on his handset or connectable electronic device and in case of acceptance, Validates/Confirms/Signs by keying in his password in the same way he is doing for the PO. This will have the effect of generating a digital signature of the DCN. The DCN together with its digital signature are then sent by “B” back to TPP. Upon receipt TPP sends a message to “C” and “A” informing about the receipt and acceptance of the books by “B” and executes the payment in favour of “A”.

### Special Lines and Accounts

Shop keepers or store owners who are interested to offer their clients the possibility to pay through the Financial Transaction Service provided by the Telecom Operator might not be willing to pay for one or several Mobile Phone subscriptions and associated Financial Transaction Accounts, that will actually never be used for voice calls.

This invention is characterised by the fact that the Telecom Operator can provide Mobile Phone lines where the voice capability is de-activated and where only data channels will be usable. Those Mobile Phone lines can also be given numbers that make them clearly recognisable by the public as data only lines or even Financial Transaction only lines. For example in China, mobile phone numbers often start by 3 distinguished digits like 139, 138, etc. . . . The “data only” mobile phone numbers could be given first 3 digits like 839, 838, etc. . . .

Generally point of sales in stores, only receive payments (this is their main function) and seldom or never need to make any payments. It can also be very convenient, for a store owner, that the Financial Transaction Accounts associated with the point of sale terminal are configured in such a way that they can only RECEIVE payments, and not be able to make any payment.

This invention is characterised by the fact that the Telecom Operator limits the possibilities of certain Financial Transaction Accounts, such as but not limited to: receiving payments from a third only, and not emitting payments to third parties.

The invention being thus described, it will be obvious that the same can be varied in many ways. Such variations are not to be regarded as a departure from the scope of the invention, and all such modifications as would be obvious to a person skilled in the art are intended to be included within the scope of the following claims.

1-58. (canceled)

59. A system enabling subscribers of a wireless Telecom Operator to execute financial transactions with a mobile phone, or an electronic device in which a subscriber has one or several open Financial Transaction Accounts being managed by the Telecom Operator, which can receive monetary deposits and on which debit and credit operations can be executed, the system comprising: can be connected to the wireless communication network,
in which
a subscriber has one or several Financial Transaction Accounts open and managed by the Telecom Operator, which can receive monetary deposits, and on which debit and credit operations can be executed,
comprising
a Transaction Processing Platform, which is a software system running on the existing computers of the Telecom Operator or on dedicated computers, and which is interfaced at least with a subscribers' data base, the a wireless communication telephone network or some data channels of the wireless communication network, an accounting system, and other different elements of the a Telecom Operator infrastructure, the Transaction Processing Platform:
receiving and interpreting financial transaction orders transmitted over the wireless telephone network via the mobile phone, and
executing the ordered financial transactions and managing related movements and operations including debiting and/or crediting related Financial Transaction accounts, confirming transactions, establishing statements of accounts, reporting transactions to Financial Transaction Account owners, sending and receiving transaction related data through the wireless telephone network to/from the mobile phones; and
which manages the financial transaction related movements and operations, including debits, credits, transaction confirmations, statement of account, reporting;
which sends and receives, through the wireless communication network, to/from the mobile phones or connectable electronic devices, transaction related data or other information, and
a client software program which can run on a mobile phone or a connectable electronic device to the wireless communication network or on the Subscriber Identity Module inserted in the mobile phones or the connectable electronic device, to perform the following functions: allowing authentication of the subscriber through password input or other means; via the mobile phone, enabling capture or validation by the subscriber and display of the financial transaction related data, and display thereof on the mobile phone, enabling, via the mobile phone, to send sending or receiving receive financial transactions transaction related data or financial transaction account information to/from the Transaction Processing Platform through the wireless communication telephone network, or through some specific data channels of such network wherein the financial transactions are executed between the mobile phones of at least two users connected to the system via the wireless telephone network and the Transaction Processing Platform.

60. A system according to claim 59, wherein each Financial Transaction Account is associated with one wireless phone line.

61. A system according to claim 59, wherein each Financial Transaction Account has an account number that is the same as a Mobile Phone number of the subscriber.

62. A system according to claim 59, wherein each Financial Transaction Account has an account number that is different from a Mobile Phone number of the subscriber.

63. A system according to claim 59, wherein terms and conditions of use of a the Financial Transaction Account are appointed in advance between the subscriber and the Telecom Operator.

64. A system according to claim 59, wherein the Financial Transaction Account is restricted to receiving payments but not to emitting payments.

65. A system according to claim 59, wherein a the wireless phone line associated with the Financial Transaction Account has its voice communication capability de-activated, and employs only data channels.

66. A system according to claim 59, wherein the Financial Transaction Account is merged with a Mobile Phone subscription account in one single account.

67. A system according to claim 59, wherein the client software program is pre-loaded or pre-existing in a memory of the subscriber's mobile phone or connectable electronic device.

68. A system according to claim 59, wherein the client software program is loaded into a memory of the subscriber's mobile phone or of the connectable electronic device, upon opening the Financial Transaction Account by such the subscriber.

69. A system according to claim 59, wherein the client software program is pre-loaded in a memory of the a Subscriber Identity Module.

70. A system according to claim 59, wherein the client software program is loaded in a memory of the a Subscriber Identity Module upon opening the Financial Transaction Account by such the subscriber.

71. A system according to claim 59, wherein the client software program is loaded over the air through the wireless telephone communication network.

72. A system according to claim 59, wherein the client software program is activated or enabled upon opening the Financial Transaction Account by the subscriber.

73. A system according to claim 59, wherein the activation of the client software program is realised realized by the input of a specific code.

74. A system according to claim 59, wherein the specific code to activate the client software program is sent over the air through the wireless communication telephone network.

75. A system according to claim 59, wherein the client software program can be is executed by a microprocessor of the subscriber's mobile phone or the subscriber's connectable electronic device.

76. A system according to claim 59, wherein the client software program can be is executed by the a microprocessor of the a Subscriber Identity Module.

77. A system according to claim 59, wherein the client software program can be is executed partly on a microprocessor of the subscriber's mobile phone or connectable electronic device, and partly on the a microprocessor of the a Subscriber Identity Module.

78. A system according to claim 59, wherein the client software program contains or can activate activates an encryption algorithm and/or a digital signature algorithm using a subscriber specific, encryption key.
